(19) United States
(12) Patent Application Publication
(10) Pub. No.: US 2011/0252844 A1
(43) Pub. Date: Oct. 20, 2011

(54) OVERHEAD DOOR LOCK WITH AUTOMATED LOCKING AND INTEGRATED DETECTION SYSTEMS

(76) Inventor: Rodney T. Shoemaker, Simi Valley, CA (US)

(21) Appl. No.: 13/089,975

(22) Filed: Apr. 19, 2011

Related U.S. Application Data
(60) Provisional application No. 61/404,115, filed on Sep. 28, 2010.
(60) Provisional application No. 61/342,635, filed on Apr. 19, 2010.
(60) Provisional application No. 61/342,630, filed on Apr. 19, 2010.

(51) Int. Cl. E05B 65/08; E05C 3/12

(52) U.S. Cl. 70/100; 292/195; 292/220; 292/201

(57) ABSTRACT

A door lock for use with an overhead door having a plurality of rollers or a bar moving along a track, includes a movable latch and a release mechanism. The movable latch is associated with the track and biased toward a door-locking position. The latch is configured to allow at least one of the rollers or bar to pass the latch as the overhead door closes. The latch is also configured to engage a roller or bar to prevent movement past the latch as the overhead door attempts to open. The release mechanism is mechanically coupled to the latch for withdrawing the latch from the track to allow the roller or bar to pass by the latch and the overhead door to open. A door position sensor is also disclosed including a movable lever and an electronic means for sensing the position of the lever.

### FIELD OF THE INVENTION

The present invention generally relates to overhead door and garage door locking and sensing mechanisms. More particularly, the present invention relates to an overhead door and garage door locking mechanism which automatically locks when the door is closed and a door position sensor that registers when the overhead door is shut.

### BACKGROUND OF THE INVENTION

Overhead door and garage door mechanisms are well known and used in a variety of installations such as residential garage doors, warehouse doors, and the like. Typically, the doors are comprised of hingedly connected individual panels which are capable of pivoting relative to other vertically arranged panels when the door is opened. Each of the panels successively shifts through an arcuate or straight path during opening movement and also in closing movement or in a reverse movement. In other cases, the door is a single panel door and capable of being moved through an arcuate or straight path to an opened position where it may be generally disposed in a horizontal position and parallel to the floor of the installation. For example, a garage door assembly may include a solid door pivotally mounted in a door frame. From a closed position, the door can move pivotally upwardly and rearwardly to an overhead, approximately horizontal position.

In either case, the door is movable in a fixed trackway or so-called “track”. Usually, a pair of tracks are located on the opposite sides of the access opening over which the door extends and the door is movable in these tracks. Moreover, the door itself may be provided with rollers rotatably connected and extending laterally from the sides of the door for rollable movement in the tracks and which thereby allows for the movement of the door relative to the tracks.

Various methods exist today for securing such overhead and garage doors to prevent any unauthorized entry by an intruder into the garage. Many residences often have a garage door secured by a padlock. These padlocks are generally located on the outside surface of the garage door and are, therefore, subject to unauthorized manipulation. Padlocks or other locks often have proven insufficient to overcome the strength and/or ingenuity of an intruder. Further, garages having garage door openers provide little security and often sacrifice security for convenience. Garage door openers comprise chain driven door openers, belt-driven door openers, and shaft driven openers and the like. Regardless of the type of garage door equipped with a garage door opener, an intruder can open such garage doors with relative ease because there is usually sufficient play in the joints, tracks, carriage, and drive connections to permit wedging of the door bottom and unauthorized entry.

Slide locks are commonly used on the inside of an overhead or garage door. Slide locks may be connected to a panel of the door and be slidably engaged with the track itself. For instance, the track can have an aperture sized accordingly for a lock to fit securely within. A slide lock may be positioned at the bottom of the door when closed, or in a higher position within reach. When the door is shut, the operator simply slides a mechanism to engage with the aperture. The door cannot be opened until the slide lock is withdrawn from the aperture.

A major problem with using a slide lock is to remember to use it. Many overhead and garage doors are used by a multitude of operators. For instance, a company can have a multitude of employees that are tasked with closing down the business at the end of the day. It is very easy to forget to use a slide lock and the end of the day. Unless it is physically viewed to verify, it impossible to verify whether the door is locked once viewed from the outside.

Additionally, many typical overhead doors are equipped with a position indicating system tied into a security monitoring system, and particularly, a magnet and reed switch position indicating system that requires a magnet be installed on the door and a reed switch be mounted on the floor, within the access opening, or on the track. Frequently one or both of the components of a magnet and reed switch position indicating system become misaligned, disabled or inoperable, due to the extreme use environment in which they are installed. This typically creates a situation where the position indicating system needs to be repaired or replaced before the security monitoring system can be effectively utilized. Where advanced security is a concern, such as with business and government warehouse or facility overhead doors, it means that the overhead door cannot be fully secured until the misaligned, disabled or inoperable component, of the magnet and reed switch position indicating system, is repaired or replaced.

Accordingly, there is a need for an automatic overhead and garage door lock that eliminates the possibility of an operator forgetting to engage it. There is also a need for a door position sensor that can register when the door is closed and which is not susceptible to misalignment and other problems. The present invention fulfills these needs and provides other related advantages.

### SUMMARY OF THE INVENTION

This application includes and references the following previously filed patents which are incorporated herein by reference: U.S. Pat. Nos. 6,027,148 filed on Jun. 12, 1998; 6,089,626 filed on Jul. 30, 1999; and 6,834,464 filed on Apr. 9, 2002.

The door lock of the present invention includes a movable latch and a release mechanism. The door lock is for use with an overhead door having a plurality of rollers or a bar moving along a track. The movable latch is associated with the track and biased toward a door-locking position. The latch is configured to allow at least one of the rollers or the bar to pass the latch as the overhead door closes. The latch is also configured to engage the at least one roller or the bar to prevent movement past the latch as the overhead door attempts to open. The release mechanism is mechanically coupled to the latch, for withdrawing the latch from the track to allow the at least one roller or the bar to pass by the latch and the overhead door to open.

In an exemplary embodiment the latch and release mechanism are disposed at an end of the track adjacent to a floor. The release mechanism may include a step-plate mechanically coupled to the movable latch. The step-plate in a first position is raised in relation to the floor and in a second position is generally adjacent to the floor after being stepped upon by the user. The step-plate may be biased in the first position by a spring. In another exemplary embodiment the release mechanism may include a solenoid, an actuator or a motor.

Another exemplary embodiment may include an electronic means for sensing the position of the latch relative to the track. This may include an electronic switch mechanically coupled to and activated by movement of the latch. The latch may be biased toward the door-locking position by a spring. An exemplary embodiment may include an electronic means associated with the latch, for sensing when the overhead door is closed and locked. An exemplary embodiment may include an electronic switch mechanically coupled to and activated by movement of the at least one roller or the bar within the track. Furthermore, the switches may be electrically coupled to a security system.

Another exemplary embodiment may include a door position sensor for use with an overhead door having a plurality of rollers or a bar moving along a track. The overhead door position sensor may include a movable lever associated with the track and biased toward a door-open position. The lever may be configured to allow at least one of the rollers or the bar to movably engage the lever as the overhead door closes.

Additionally, electronic means are associated with the lever for sensing when the overhead door is closed. This is accomplished by sensing the position of the lever relative to the track. The lever and electronic means are disposed at an end of the track adjacent to a floor. The electronic means can include an electronic switch mechanically coupled to and activated by movement of the lever. The lever may be biased toward the door-open position by a spring. Also, the electronic switch may be electrically coupled to a security system.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an inside perspective view of an exemplary overhead door lock embodying the present invention;

FIG. 2 is an inside perspective view similar to FIG. 1, now with the overhead door open;

FIG. 3 is an inside perspective view of an exemplary overhead door lock embodying the present invention;

FIG. 4 is an inside perspective view similar to FIG. 3, now with the rolling coil door open;

FIG. 5 is a perspective view of an exemplary overhead door lock embodying the present invention;

FIG. 6 is an exploded perspective view of the structure of FIG. 5;

FIG. 7 is an enlarged perspective view illustrating the internal components of the overhead door lock;

FIG. 8 is a reverse perspective view of the structure of FIG. 7, now with the latch removed;

FIG. 9 is a side view of the structure of FIG. 5;

FIG. 10 is a sectional view taken along line 10-10, illustrating the configuration also shown in FIG. 9 with the roller locked below the latch;

FIG. 11 is a sectional view similar to the configuration shown in FIG. 10, now where the roller is engaging the latch.

FIG. 12 is a perspective view of the structure of FIG. 5, now with the roller below the latch;

FIG. 13 is a perspective view similar to FIG. 12, now with the roller engaging the latch;

FIG. 14 is a perspective view similar to FIG. 12, now with the roller above the latch;

FIG. 15 is a perspective view of the structure of FIG. 5, now with the roller below the latch and showing the sectional doors;

FIG. 16 is a perspective view of the structure of FIG. 5, now with the roller engaging the latch and showing the sectional doors;

FIG. 17 is a side view of an exemplary overhead door position sensor embodying the present invention;

FIG. 18 is a sectional view taken along line 18-18, illustrating the internal components of the overhead door position sensor;

FIG. 19 is a sectional view similar to the FIG. 18, now with the lever and electronic switch not being engaged;

FIG. 20 is a perspective view of the structure of FIG. 18;

FIG. 21 is a perspective view of the structure of FIG. 19; and

FIG. 22 is an inside perspective view of the structure of FIG. 17.

### DETAILED DESCRIPTION OF THE PREFERRED EMBODIMENTS

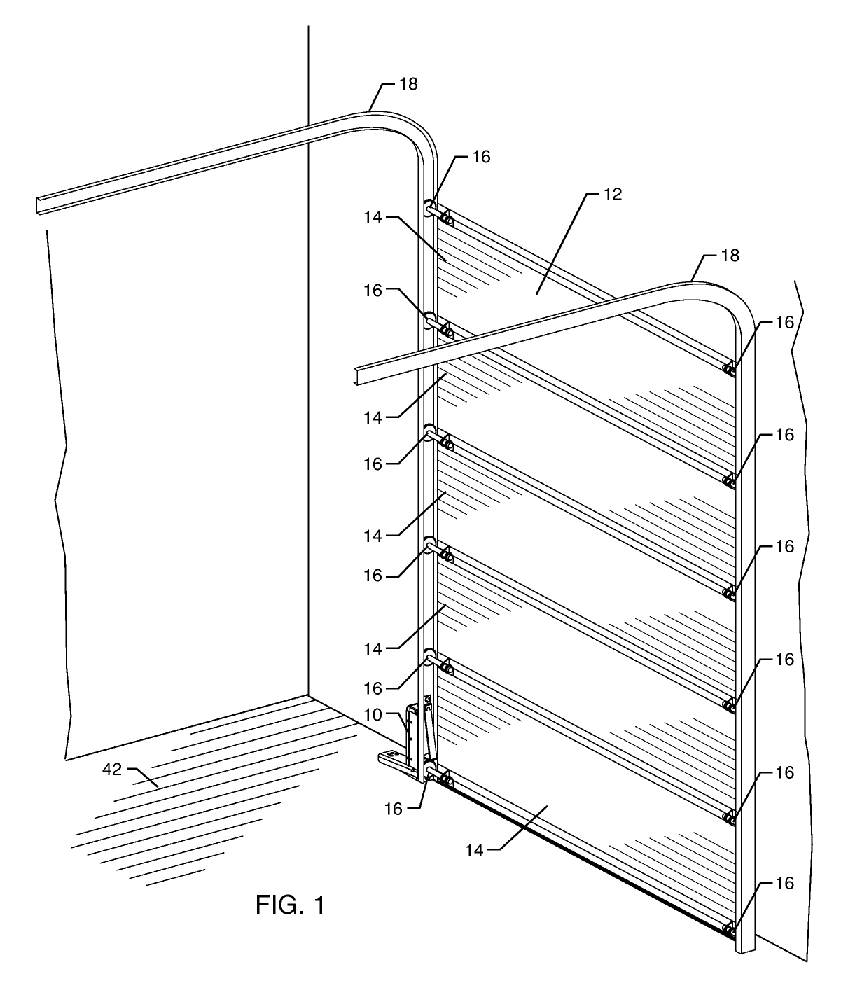

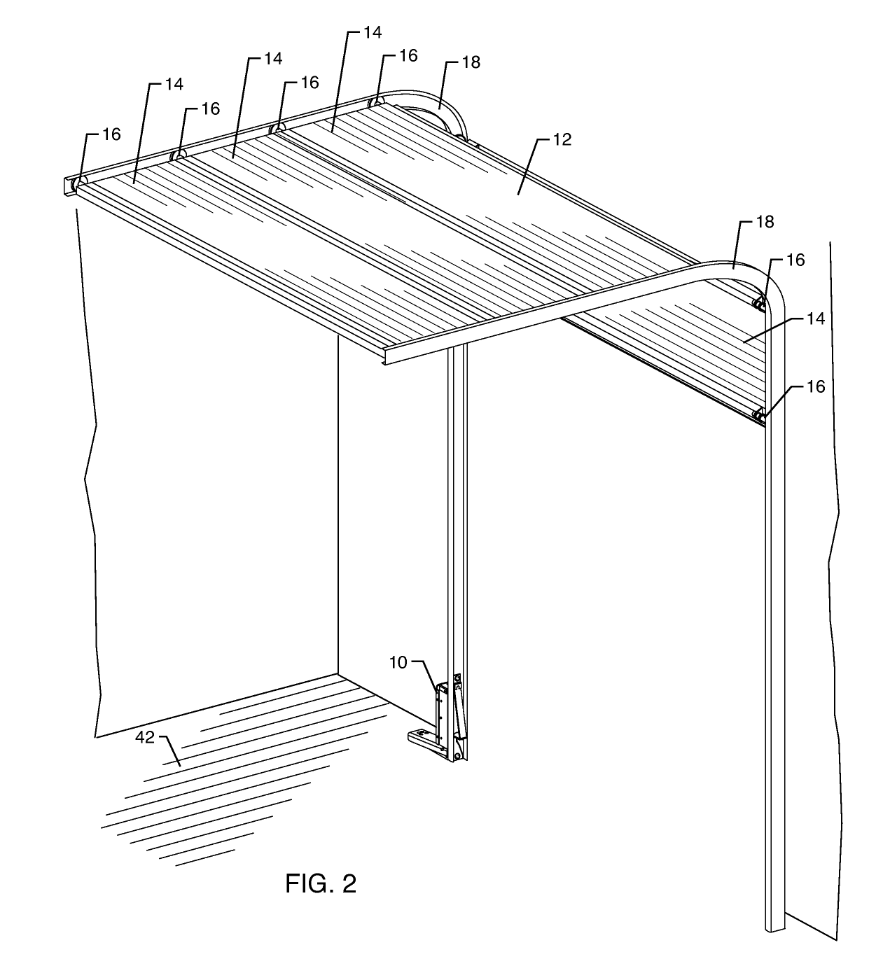

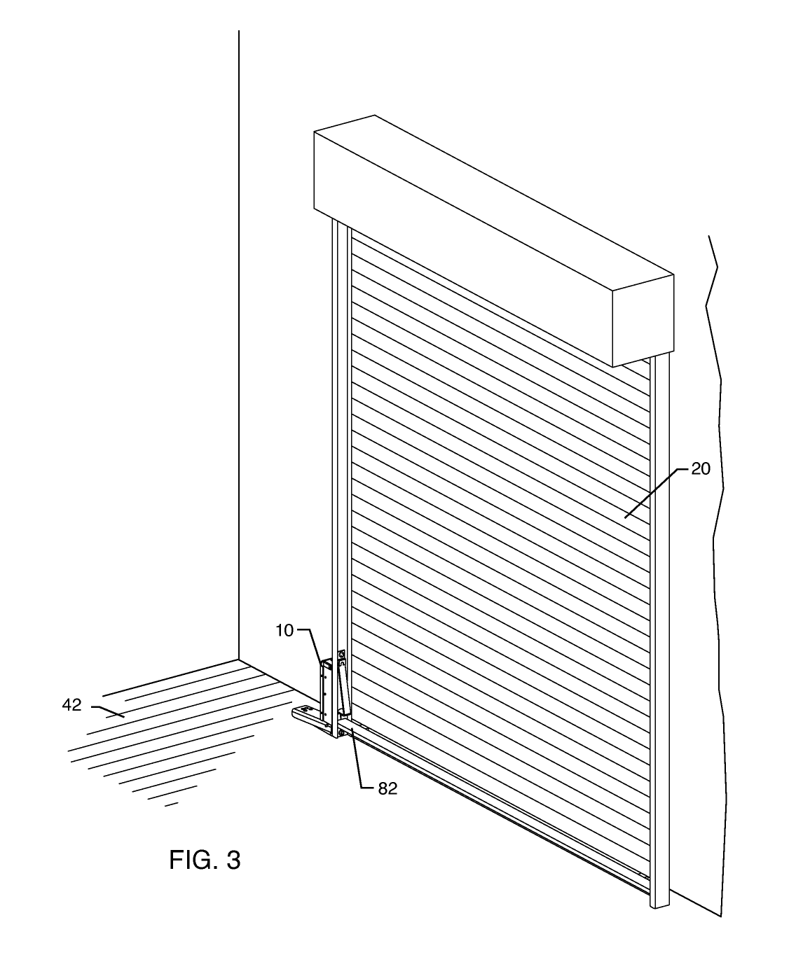

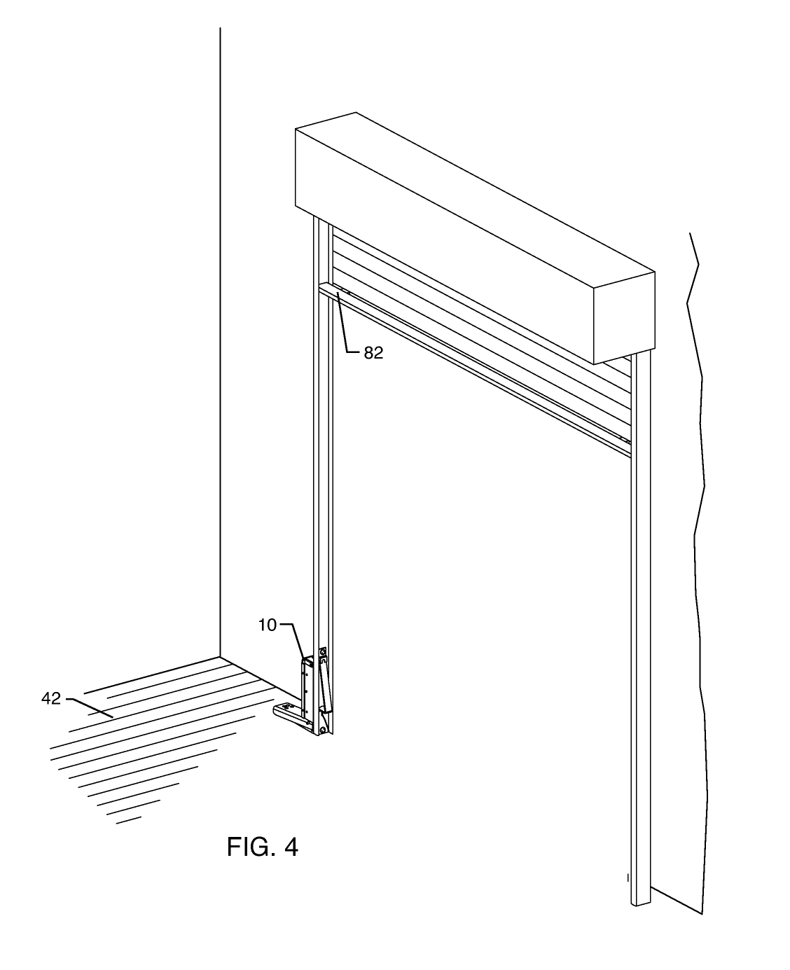

As shown in the drawings for purposes of illustration, the present invention for an overhead door lock is referred to generally by the reference number 10. FIG. 1 is an inside perspective view of an exemplary overhead door lock 10 embodying the present invention. An overhead door 12 includes a series of sectional panels 14. The overhead door 12 includes a plurality of rollers 16 which move along a track 18. FIG. 2 is an inside perspective view similar to FIG. 1, now with the overhead door 12 open. FIG. 3 is an inside perspective view of an exemplary overhead door lock 10 embodying the present invention now used with a rolling coil door 20. FIG. 4 is an inside perspective view similar to FIG. 3, now with the rolling coil door 10 open.

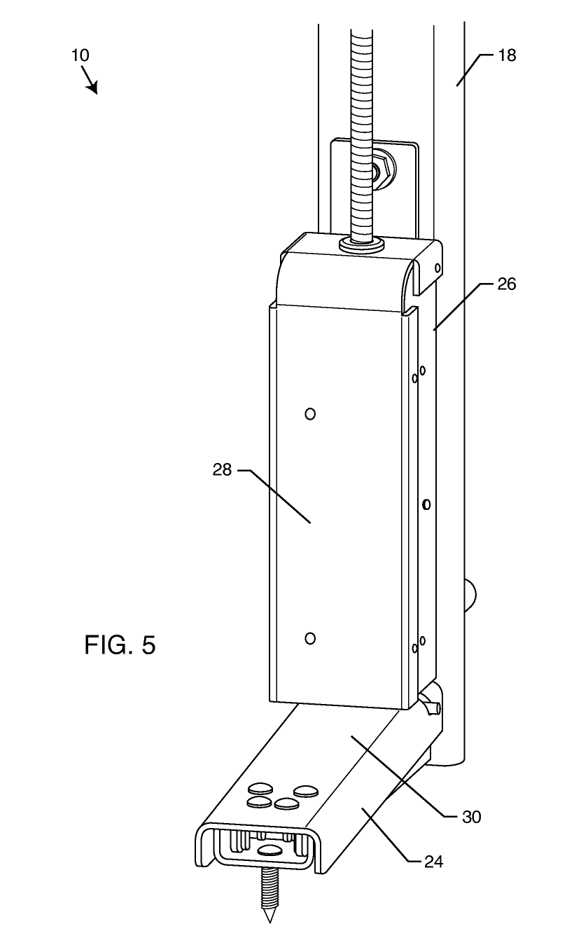

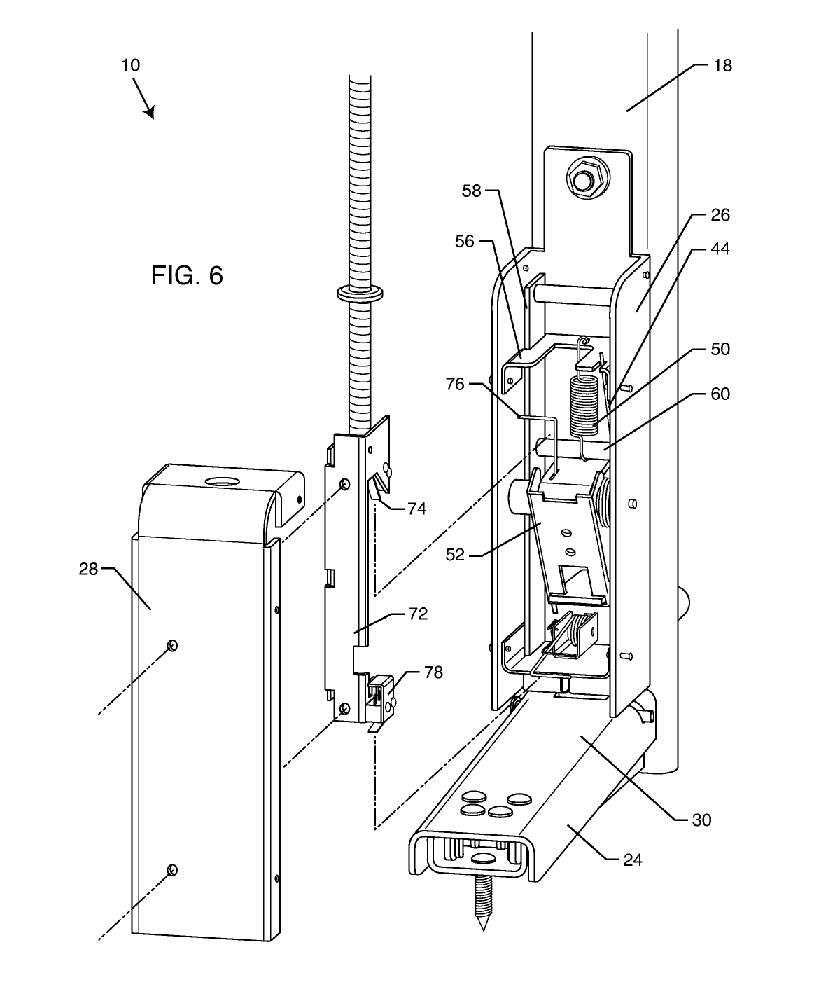

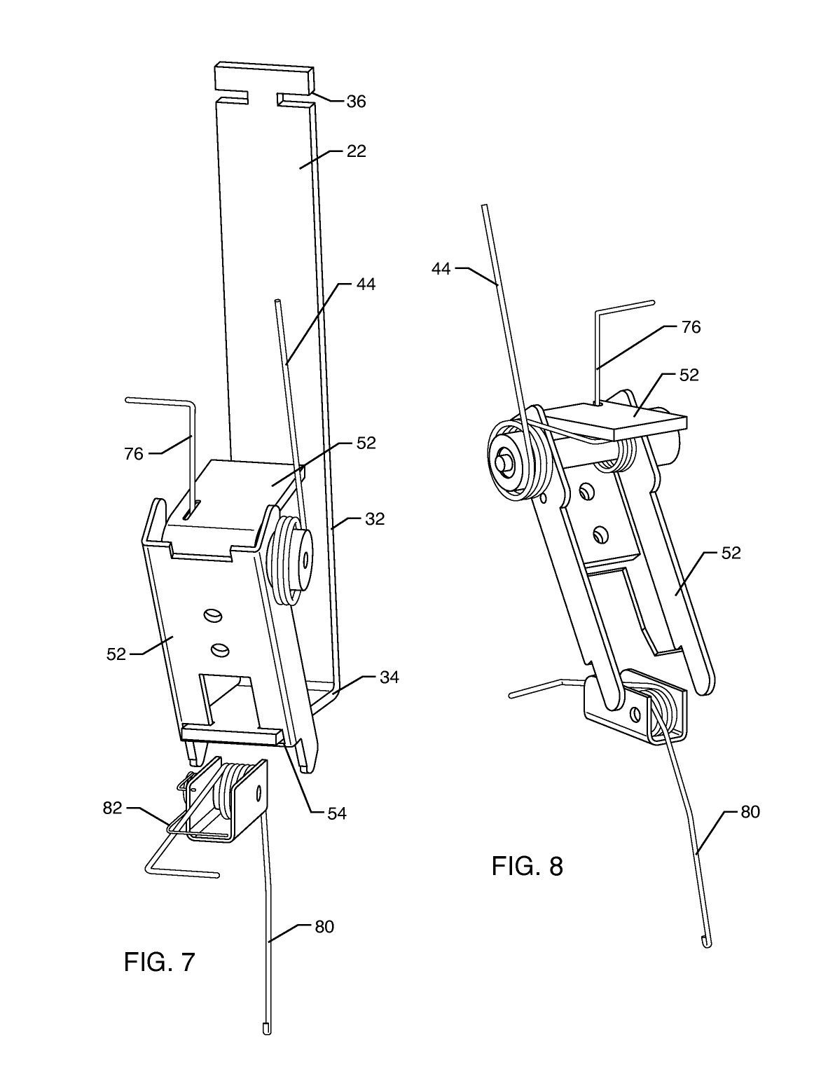

FIGS. 5-8 show the internal mechanisms of the door lock 10 in more detail. FIG. 5 is a perspective view of the door lock 10 mounted to the track 18. FIG. 6 is an exploded perspective view of the structure of FIG. 5. FIG. 7 is an enlarged perspective view illustrating internal components of FIG. 6 and FIG. 8 is a reverse perspective view of the structure of FIG. 7.

The door lock 10 of the present invention includes a movable latch 22 and a release mechanism 24. A housing 26 contains the internal mechanisms of the latch 22. A housing cover 28 attaches to the outside of the housing 26. The release mechanism 24 is positioned below the housing 26 and can include a step-plate 30.

The latch 22 includes a beveled or angled end 32 and a stop end 34. The latch 22 may be formed as one continuous piece and transition from the beveled end 32 to the stop 34. In this embodiment, the latch 22 is pivotably connected at the notch 36. It is to be understood by one skilled in the art that the latch 22 could translate or pivot in a different means and still accomplish the same functionality, as this teaching is not limited to the precise form described herein.

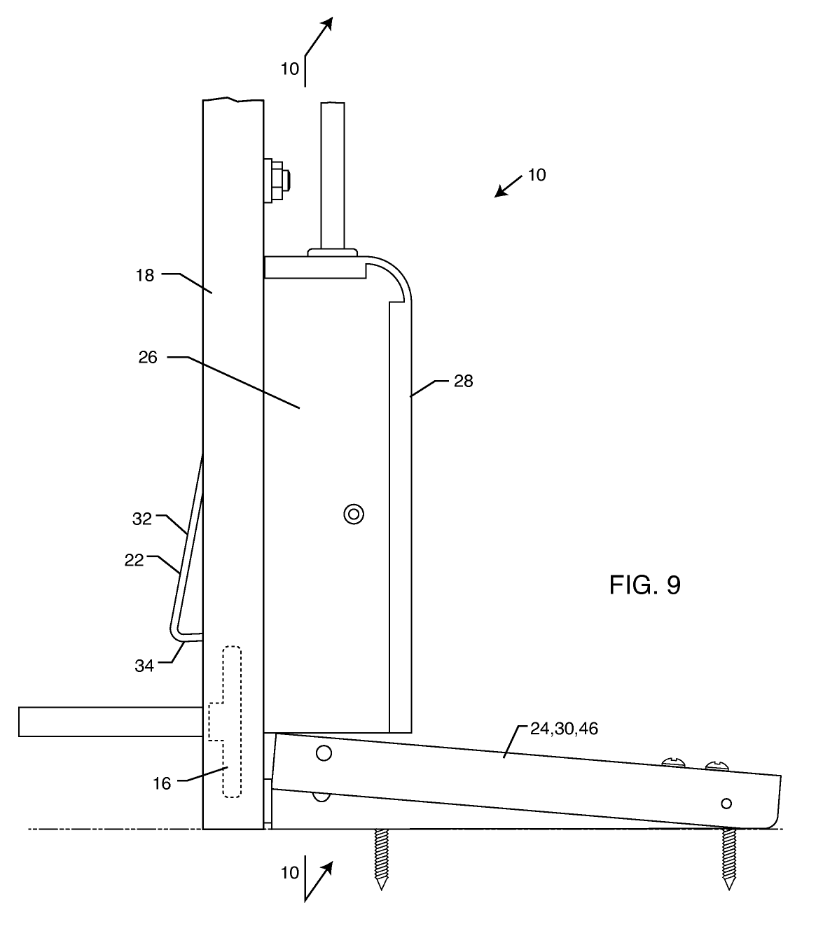

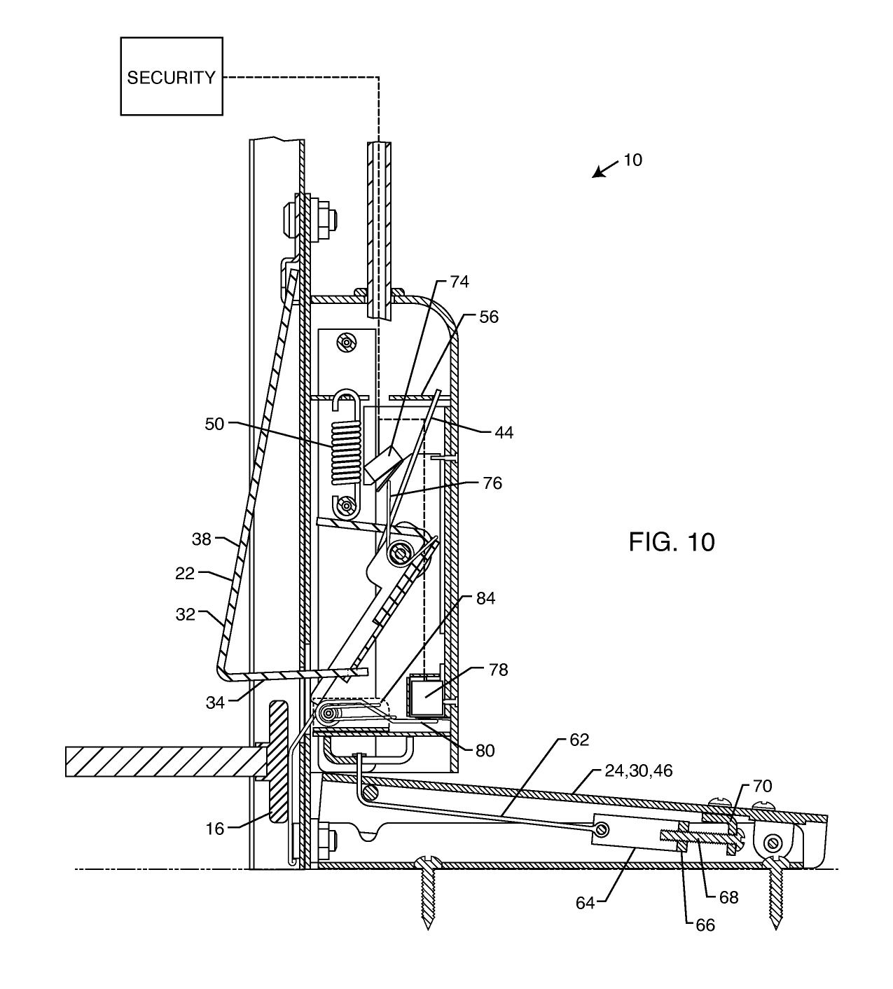

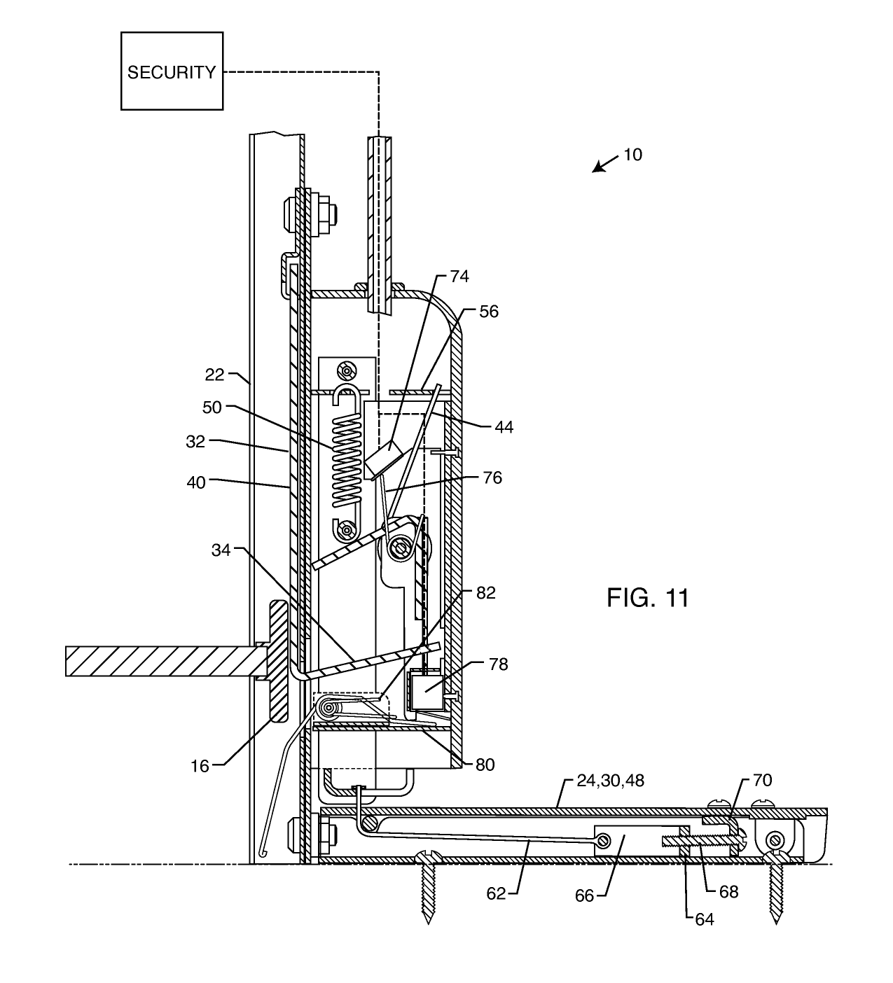

The latch 22 is installed such that it is disposed within the track 18. The latch 22 is biased toward a door-locking position 38, as is best shown in FIG. 10. The latch 22 is configured to allow at least one of the rollers 16 to pass the latch 22 as the overhead door 12 closes, as is best shown in FIGS. 11, 13 and 16. As the overhead door 12 moves down, the roller 16 starts to engage the latch 22 along the beveled or angled end 32. The roller 16 overcomes the bias of the latch 22 to be in the door-locking position 38 and forces the latch 22 to retract into a retracted position 40. Once the roller 16 passes the end of the latch 22, the latch 22 will bias back into the door-locking position 38, as is best shown in FIGS. 9, 10, 12 and 15. The stop 34 of the latch 22 is now a barrier to the roller 16 moving upwards. The overhead door 12 cannot open until the latch 22 is retracted from the track 18, yet retraction can now only be facilitated with use of a manual release mechanism 24 and/or other means such as a solenoid, an actuator or a motor.

To retract the latch 22 after a roller is below the stop 34, the release mechanism 24 must be activated by a user. In these exemplary embodiment the latch 22 and release mechanism 24 are disposed at an end of the track 18 adjacent to a floor 42. The release mechanism may include the step-plate 30 mechanically coupled to the movable latch 22. The step-plate 30 in a first position 46 is raised in relation to the floor 42, as is best shown in FIGS. 9 and 10. When the step-plate 30 is in a second position 48 it is generally adjacent to the floor 42 after being stepped upon by the user, as is best shown in FIG. 11.

A multitude of springs are located within the housing 26 to control various portions of the internal mechanisms and to activate various switches. The latch 22 is kept biased in the door-locking position 38 by a latch spring 44. The latch spring 44 is then compressed when the roller 16 moves into engagement with the beveled end 32 of the latch. The latch spring 44 also returns the latch 22 to the door-locking position 38 once the roller 16 is below the stop 34 of the latch 22. It is also noted that the latch spring 44 returns the latch 22 to the door-locking position 38 once the roller is above the stop 34 and latch 22. Whenever the roller 16 is not engaged directly with the latch 22, the latch 22 is in the door-locking position 38.

The latch spring 44 engages the latch 22 through a pivot assembly 52. In these embodiments the pivot assembly 52 is made of two metallic parts which are bolted, riveted, welded or fastened together and act as one unit. The pivot assembly 52 captures the bottom of the latch 22 near the stop 34. The latch 22 has a notch 54 which is engaged by the pivot assembly 52. The latch spring 44 puts pressure between the pivot assembly 52 and a support 56 attached to the housing 26. This pressure then biases the latch 22 to be in the door-locking position 38.

The step-plate 30 is also kept in the first position 46 by a release mechanism spring 50. The spring 50 is attached to the support 56 at one spring end and to a carriage assembly 58 at the other spring end. The carriage assembly 58 is disposed along the vertical length on the inside of the housing 26 and can slide up and down. The spring 50 keeps the carriage assembly 58 in an upmost position.

The carriage assembly 58 interacts with the pivot assembly 52 through a rod 60. The rod 60 abuts the pivot assembly 52. When the carriage assembly 58 is pulled down, it therefore abuts the pivot assembly 52 and forces it to pivot. When the carriage assembly 58 is pulled down, it then retracts the latch 22 from the door-locking position 38 to the retracted position 40.

The carriage assembly 58 is pulled down when the step-plate 30 is moved manually by the user from the first position 46 to the second position 48. The step-plate 30 is connected to the carriage assembly 58 through a wire or cable 62. When the step-plate 30 moves down, the cable 62 pulls on the carriage assembly 58 which moves down and in turn abuts the pivot assembly 52 which then forces the latch 22 to retract. The length of the cable 62 can be adjusted through a screw adjustment means 64. The screw adjustment means 64 includes a threaded block 66 which is attached to the wire 62 and is connected to a screw 68. The screw 68 is held in location against the support 70. As one turns the screw 68, it either lengthens or shortens the overall length of the wire 62. Alternatively, the threaded block 66 may be replaced with a nut positioned behind an unthreaded block. In either embodiment the adjustability aids in installation of the overhead door lock 10 as different locations require fine adjustments for perfect operation of the door lock 10.

In these embodiments, the release mechanism 24 includes a step-plate 30 which is pressed by the user when the user steps upon the step-plate 30. It is to be also understood by those skilled in the art, that the release mechanism may be substituted with or assisted by an electronic means of activation including a solenoid, an actuator or a motor. It is also understood by those skilled in the art that the step-plate 30 may be substituted with a hand actuated lever or other means for activation, be it manual or assisted.

Connected to the housing cover 28 is a switch bracket 72 that includes two electronic switches. The switch bracket 72 may include an electronic means for sensing the position of the latch 22 relative to the track 18. This may include an electronic switch 74 mechanically coupled to and activated by movement of the latch 22. The electronic switch 74 is activated by a latch switch spring 76 that moves with the pivot assembly 52. The spring 76 is used to account for variances of assembly and to not apply to hard a force to the electronic switch 74. The spring 76 accounts for an overrun of movement and prevents the electronic switch 74 from receiving excessive force. The electronic switch 74 can then register whether the latch 22 is in the door-locking position 38 or the retracted position 40. The electronic switch 74 can then be electrically coupled and wired into a security system of a building. The security system can then be configured to notify the user if the latch 22 is in a wrong position or a light or audible noise can be activated as well.

An exemplary embodiment may include an electronic means associated with the latch 22 for sensing when the overhead door 12 is closed and locked. An exemplary embodiment may include an electronic switch 78 mechanically coupled to and activated by movement of the at least one roller 16 within the track. The electronic switch 78 is also coupled to the switch bracket 72. When the roller 16 is below the stop 34, a door position sensing spring 80 can be engaged. The spring 80 extends into the track 18 just below the stop 34. When the overhead door 12 is locked by the latch 22, the roller 16 engages with the spring 80 which then interacts with the electronic switch 78. When the roller 16 moves upward, the spring 80 is released from engagement with the roller 16. The spring 80 also allows for an overrun of travel such that excessive force is not transmitted to the electronic switch 78. To help keep the spring 80 in a ready position to detect movement of the roller 16, secondary spring 84 biases the spring 80 to a ready position. Without the secondary spring 84, the spring 80 would flop around or may inadvertently activate switch 78 when the roller 16 was not engaging it. The electronic switch 78 can also be electrically coupled to a security system just as electronic switch 74.

FIG. 9 is a side view of the structure of FIG. 5. FIG. 10 is a sectional view taken along line 10-10, illustrating the configuration also shown in FIG. 9 with the roller 16 locked below the latch 22. FIG. 10 has the latch 22 in the door-locking position 38 and the step-plate 30 in the first position. In FIG. 10, the spring 80 is engaging the electronic switch 78 while the spring 76 is not engaging the electronic switch 74.

FIG. 11 is a sectional view similar to the configuration shown in FIG. 10, now where the roller 16 is engaging the latch 22. In FIG. 11, the latch 22 is in the retracted position 40 and the step-plate 30 is in the second position 48. This allows the roller 16 to pass by the stop 34 and for the overhead door 12 to open. Also in FIG. 11, the spring 76 is engaging the electronic switch 74 while the spring 80 is not engaging the electronic switch 78.

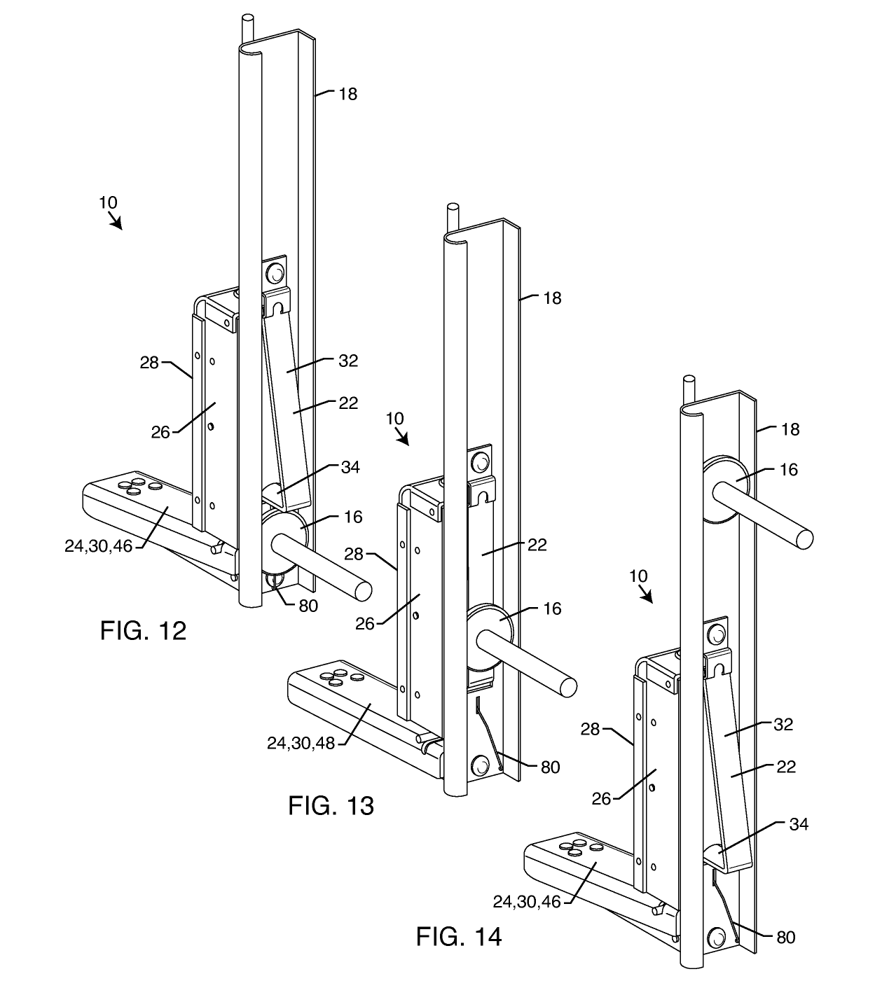

FIG. 12 is a perspective view of the structure of FIG. 5, now with the roller 16 below the latch 22. It is easy now to see how the latch 22 is disposed within the track 18. The roller 16 is engaging the spring 80 and is prevented from movement upwards due to the stop 34. Furthermore in FIG. 12, the roller 16 is engaging the spring 80 which in turn activates electronic switch 78. Electronic switch 74 is not activated in FIG. 12.

FIG. 13 is a perspective view similar to FIG. 12, now with the roller 16 engaging the latch 22. The step-plate 30 has been moved into the second position 48. When the step-plate 30 is moved to the second position 48, it retracts the latch 22 into the retracted position 40 and allows the roller 16 to pass by the stop 34. Furthermore in FIG. 13, the roller 16 is engaging the latch 22 which in turn engages spring 76 which then activates electronic switch 74. Electronic switch 78 is not activated in FIG. 13.

FIG. 14 is a perspective view similar to FIG. 12, now with the roller 16 above the latch 22. In FIG. 14, neither electronic switch 74 or electronic switch 78 are activated as the roller 16 is above the latch 22.

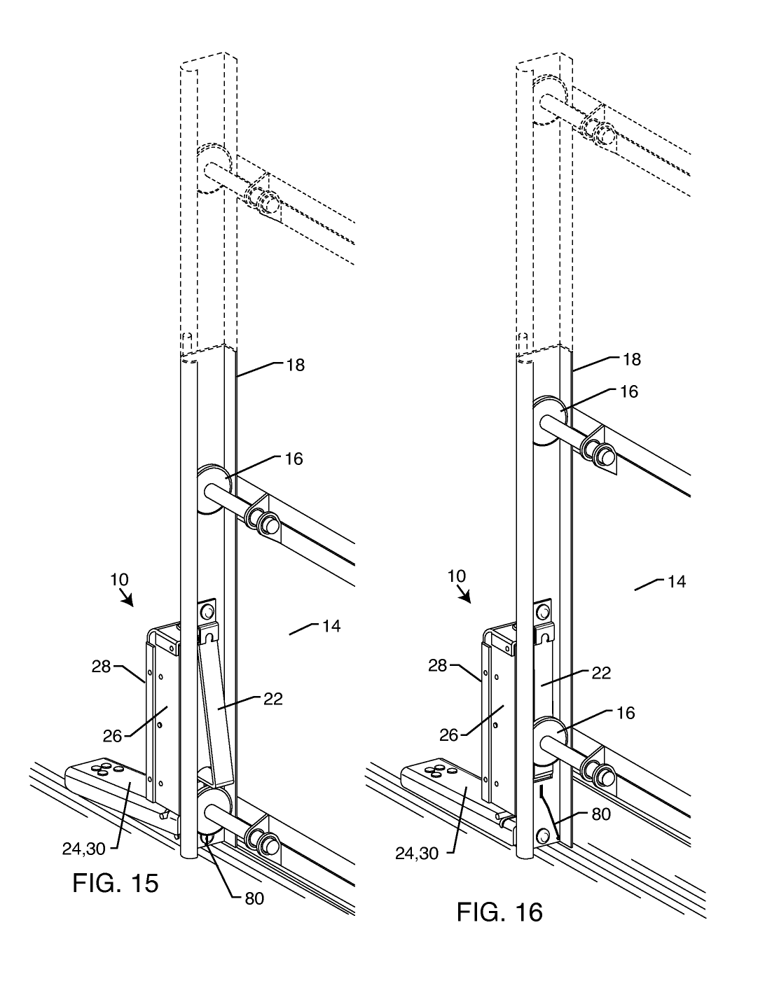

FIG. 15 is a perspective view of the structure of FIG. 5, now with the roller 16 below the latch 22 and showing the sectional panels 14 of the overhead door 12. FIG. 16 is a perspective view of the structure of FIG. 5, now with the roller 16 engaging the latch 22 and showing the sectional panels 14 of the overhead door 12.

Going back to FIGS. 3 and 4, the overhead door lock 10 can also be used with a rolling coil door 20. Rather than the latch 22 engaging a roller 16, the latch 22 may engage a bar 82. The bar 82 would act in a similar manner as the roller 16 of the overhead door 12. The bar 82 may already be part of the door 20 which can be used to engage the latch 22 or the bar 82 may be a separate part that is added to an existing door 20. As can be seen by one skilled in the art either a roller 16, a bar 82 or other structures may be devised to interact with the latch 22 of the door lock 10 and this disclosure is not to be limited to the precise forms shown and described herein.

As can be seen by this disclosure, the door lock 10 prevents an overhead door 12 or 20 from not being locked as soon as it is closed. Every time the overhead door 12 or 20 is closed, it is automatically locked by the door lock 10. The default result of the door lock 10 is that the overhead door 12 or 20 is always locked when closed. To open the overhead door 12 or 20, a user must activate the release mechanism 24 such that an unintended opening of the overhead door 12 or 20 never occurs.

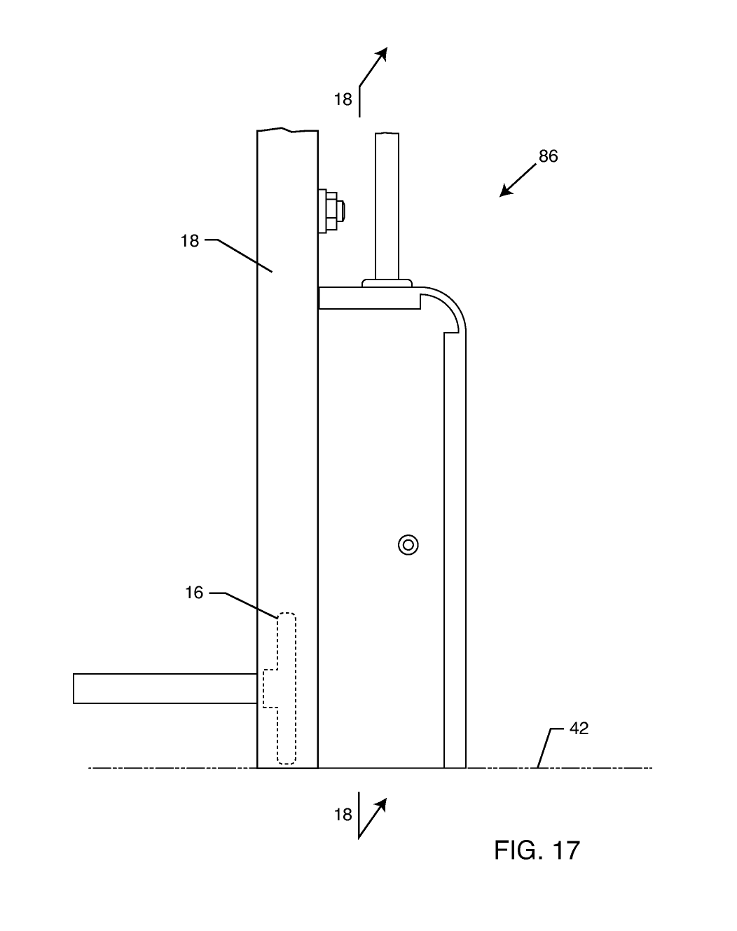

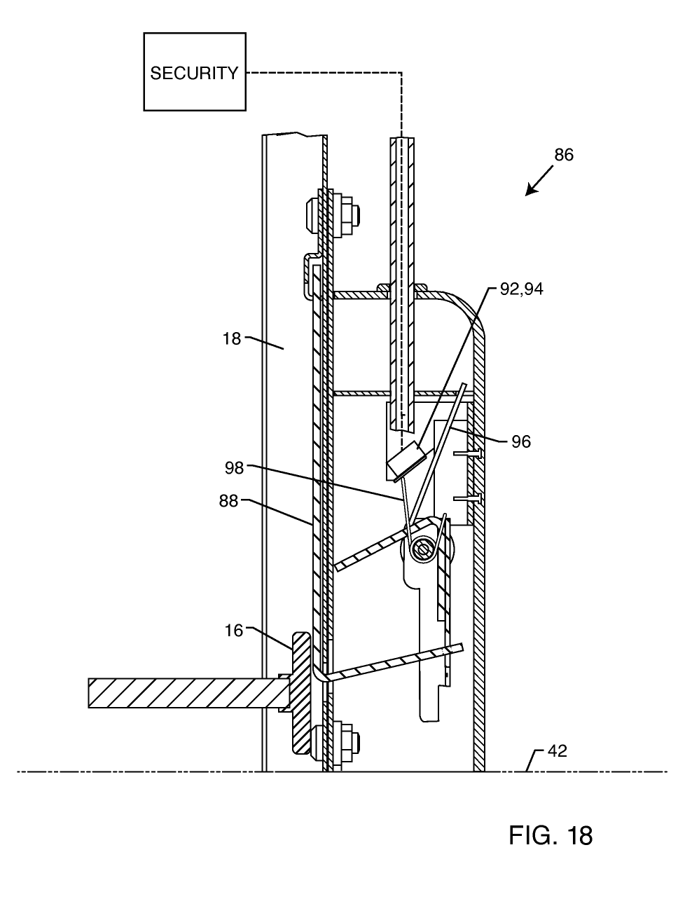

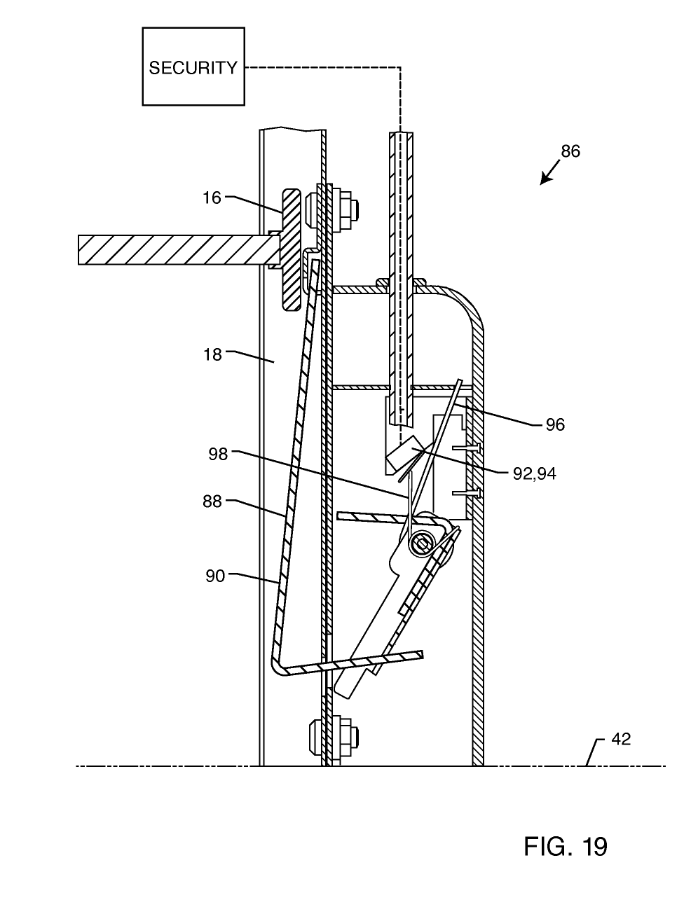

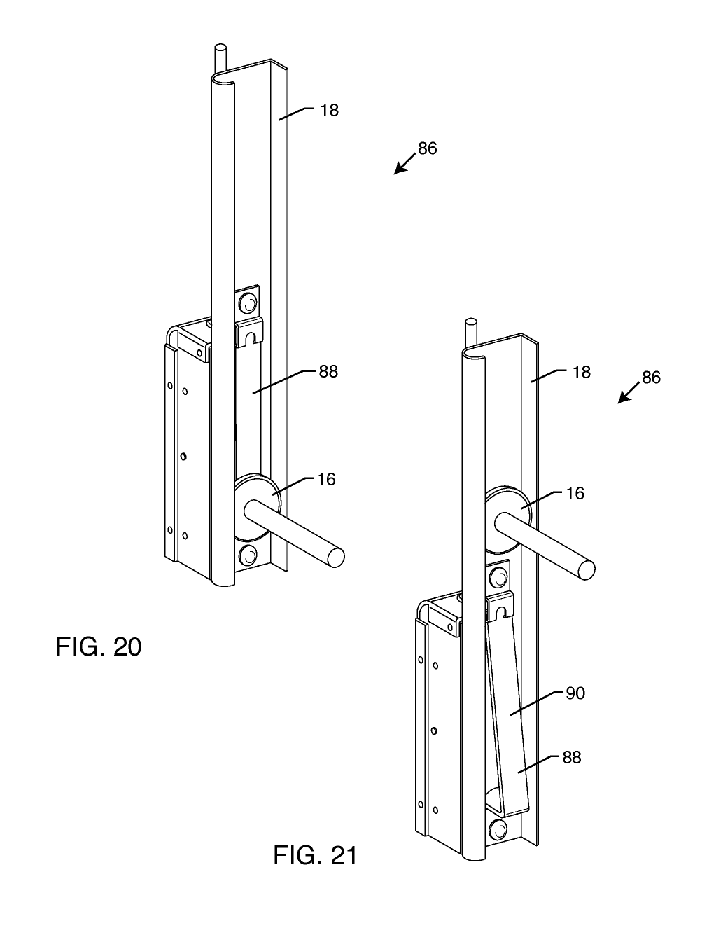

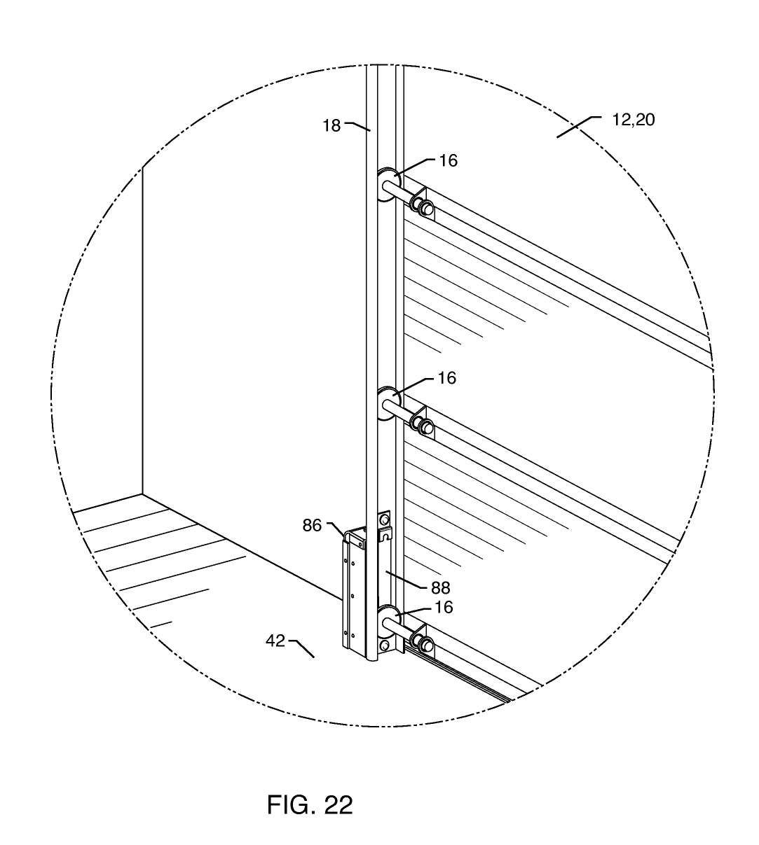

As shown in FIGS. 17-22, another exemplary embodiment may include a door position sensor 86 for use with an overhead door 10 or 20 moving along a track 18. FIG. 17 is a side view of an exemplary overhead door position sensor 86 embodying the present invention. FIGS. 18 and 19 are a sectional views taken along line 18-18, illustrating the internal components of the overhead door position sensor 86. FIG. 20 is a perspective view that corresponds to sectional view of FIG. 18 and FIG. 21 is a perspective view that corresponds to the sectional view of FIG. 19. FIG. 22 is an inside perspective view of the structure of FIG. 17.

The overhead door 10 or 20 may use either a roller 16 or a bar 82 as previously disclosed herein. The overhead door position sensor 86 may include a movable lever 88 associated with the track 18 and biased toward a door-open position 90. The lever 88 is similar in shape to the latch 22 previously described above, but now is utilized differently to only determine when the overhead door 12 or 20 is closed or open. In the embodiments in FIG. 17-22, the roller 16 or bar 82 never passes below the lever 88. The lever 88 now is used to detect and register when the overhead door 12 or 20 is closed or open.

As shown in FIGS. 19 and 21 the lever 88 may be biased toward the door-open position 90 by a spring 96. The lever 88 may be configured to allow at least one of the rollers 16 or the bar 82 to movably engage the lever 88 as the overhead door 10 or 20 closes. When the overhead door 12 or 20 closes, the roller 16 or bar 82 engages the lever 88 and forces the lever 88 to shut, as is shown in FIGS. 17, 18, 20 and 22.

Electronic means 92 are associated with the lever 88 for sensing when the overhead door 10 or 20 is closed or open. This is accomplished by sensing the position of the lever 88 relative to the track. The lever 88 and electronic means 92 are disposed at an end of the track 18 adjacent to a floor 42. The electronic means 92 can include an electronic switch 94 mechanically coupled to and activated by movement of the lever 88. The electronic switch 94 may be activated by a spring 98 that is connected relative to the lever 88 and the electronic switch 94. The spring 98 accounts for an overrun of movement and prevents the electronic switch 94 from receiving excessive force. Additionally, the electronic switch 94 may be electrically coupled to a security system.

In FIGS. 17, 18, 20 and 22, the lever 88 is being engaged by the roller 16. This means that it then forces the spring 98 to engage with the electronic switch 94. Then a signal can be sent to a security system that the overhead door is closed. Alternatively, in FIGS. 19 and 21 the roller 16 is above the lever 88 such that the spring 98 does not engage the electronic switch 94. Then a signal can be sent to the security system that the overhead door 12 or 20 is open and not fully closed. As can be seen, the lever 88 is a mechanical means of determining when the overhead door 12 or 20 is closed or open and is not susceptible to the many problems plagued by the prior art.

Although several embodiments have been described in detail for purposes of illustration, various modifications may be made to each without departing from the scope and spirit of the invention. Accordingly, the invention is not to be limited, except as by the appended claims.

What is claimed is:

1. A door lock for use with an overhead door having a plurality of rollers or a bar moving along a track, the overhead door lock comprising:
a moveable latch associated with the track and biased toward a door-locking position, the latch being configured to allow at least one of the rollers or the bar to pass the latch as the overhead door closes, and engage the at least one roller or the bar to prevent movement past the latch as the overhead door attempts to open; and
a release mechanism mechanically coupled to the latch, for withdrawing the latch from the track to allow the at least one roller or the bar to pass by the latch and the overhead door to open.

2. The overhead door lock of claim 1, wherein the latch and release mechanism are disposed at an end of the track adjacent to a floor.

3. The overhead door lock of claim 2, wherein the release mechanism comprises a step-plate mechanically coupled to the movable latch.

4. The overhead door lock of claim 3, wherein the step-plate in a first position is raised in relation to the floor and in a second position is generally adjacent to the floor after being stepped upon by the user.

5. The overhead door lock of claim 4, wherein the step-plate is biased in the first position by a spring.

6. The overhead door lock of claim 2, wherein the release mechanism comprises a solenoid, an actuator or a motor.

7. The overhead door lock of claim 1, including electronic means for sensing the position of the latch relative to the track.

8. The overhead door lock of claim 7, including an electronic switch mechanically coupled to and activated by movement of the latch.

9. The overhead door lock of any of claim 7 or 8, wherein the latch is biased toward the door-locking position by a spring.

10. The overhead door lock of claim 1 or 7, including electronic means associated with the latch, for sensing when the overhead door is closed and locked.

11. The overhead door lock of claim 10, including an electronic switch mechanically coupled to and activated by movement of the at least one roller or the bar within the track.

12. The overhead door lock of claim 11, wherein the switches are electrically coupled to a security system.

13. A door lock for use with an overhead door having a plurality of rollers moving along a track, the overhead door lock comprising:
a movable latch associated with the track and biased toward a door-locking position, the latch being configured to allow at least one of the rollers to pass the latch as the overhead door closes, and engage the at least one roller to prevent movement past the latch as the overhead door attempts to open;
electronic means associated with the latch, for sensing when the overhead door is closed and locked; and
a release mechanism mechanically coupled to the latch, for withdrawing the latch from the track to allow the at least one roller to pass by the latch and the overhead door to open;
wherein the latch and release mechanism are disposed at an end of the track adjacent to a floor.

14. The overhead door lock of claim 13, wherein the release mechanism comprises a step-plate mechanically coupled to the movable latch.

15. The overhead door lock of claim 14, wherein the step-plate in a first position is raised in relation to the floor and in a second position is generally adjacent to the floor after being stepped upon by the user, and wherein the step-plate is biased in the first position by a spring.

16. The overhead door lock of claim 13, wherein the release mechanism comprises a solenoid, an actuator or a motor.

17. The overhead door lock of claim 13, including an electronic switch mechanically coupled to and activated by movement of the at least one roller within the track.

18. The overhead door lock of claim 17, wherein the switches are electrically coupled to a security system.

19. The overhead door lock of claim 17, including electronic means for sensing the position of the latch relative to the track, and an electronic switch mechanically coupled to and activated by movement of the latch.

20. The overhead door lock of claim 19, wherein the latch is biased toward the door-locking position by a spring.

21. A door position sensor for use with an overhead door having a plurality of rollers or a bar moving along a track, the overhead door position sensor comprising:
a movable lever associated with the track and biased toward a door-open position, the lever being configured to allow at least one of the rollers or the bar to movably engage the lever as the overhead door closes; and
electronic means associated with the lever for sensing when the overhead door is closed or open by sensing the position of the lever relative to the track.

22. The overhead door position sensor of claim 21, wherein the lever is biased toward the door-open position by a spring.

23. The overhead door position sensor of claim 21, wherein the movable lever is disposed at an end of the track adjacent to a floor.

24. The overhead door position sensor of claim 21, including an electronic switch mechanically coupled to and activated by movement of the lever.

25. The overhead door position sensor of claim 24, wherein the electronic switch is electrically coupled to a security system.
